(19) United States
(12) Patent Application Publication
(10) Pub. No.: US 2025/0371694 A1
(43) Pub. Date: Dec. 4, 2025

(54) METHOD OF IMAGE QUALITY EVALUATION, ELECTRONIC DEVICE, AND STORAGE MEDIUM

(71) Applicants: Beijing Zitiao Network Technology Co., Ltd., Beijing (CN); Lemon Inc., Grand Cayman (KY)

(72) Inventors: Tianwu ZHI, Beijing (CN); Yabin ZHANG, Los Angeles, CA (US); Guiyan CAO, Beijing (CN); Gen ZHAN, Beijing (CN); Yiting LIAO, Los Angeles, CA (US)

(21) Appl. No.: 19/195,946

(22) Filed: May 1, 2025

(30) Foreign Application Priority Data
May 30, 2024 (CN) 202410692395.X

(51) Int. Cl. G06T 7/00; G06V 10/776; G06V 10/82

(52) U.S. Cl. CPC G06T 7/0002; G06V 10/776; G06V 10/82; G06T 2207/10016; G06T 2207/20081; G06T 2207/20084; G06T 2207/30168

(57) ABSTRACT

A method of image quality evaluation, an electronic device, and a storage medium are provided. The method includes: obtaining a target image to be evaluated, the target image beings generated based on a neural network model and a target prompt text; inputting the target image and the target prompt text to a target quality evaluation model, the target quality evaluation model performing quality evaluation, based on target image feature information corresponding to the target image, target text feature information corresponding to the target prompt text, and interactive feature information, the interactive feature information being obtained by fusing the target image feature information and the target text feature information; and determining a target quality evaluation result corresponding to the target image based on an output of the target quality evaluation model.

### CROSS-REFERENCE TO RELATED APPLICATION

The present disclosure claims priority of the Chinese Patent Application No. 202410692395.X filed on May 30, 2024, the disclosure of which is incorporated herein by reference in its entirety as part of the present application.

### TECHNICAL FIELD

Embodiments of the present disclosure relate to a method of image quality evaluation, an electronic device, and a storage medium

### BACKGROUND

With the rapid development of computer technology, it is often necessary to evaluate the quality of generated images to obtain a desired generation effect of the images. Currently, image quality evaluation is usually performed based on characteristics of the images, such as color, texture, and sharpness. However, results obtained by performing such quality evaluation on the generated images based on only the characteristics of the images have some deviations from the actual image quality, reducing the accuracy of the image quality evaluation.

### SUMMARY

The present disclosure provides a method and apparatus of image quality evaluation, a device, and a storage medium, to improve the accuracy of image quality evaluation.

An embodiment of the present disclosure provides a method of image quality evaluation. The method includes:

obtaining a target image to be evaluated, the target image being generated based on a neural network model and a target prompt text;

inputting the target image and the target prompt text to a target quality evaluation model, where the target quality evaluation model performs quality evaluation, based on target image feature information corresponding to the target image, target text feature information corresponding to the target prompt text, and interactive feature information, where the interactive feature information is obtained by fusing the target image feature information and the target text feature information; and

determining a target quality evaluation result corresponding to the target image based on an output of the target quality evaluation model.

An embodiment of the present disclosure further provides an apparatus of image quality evaluation. The apparatus includes:

a target image obtaining module, configured to obtain a target image to be evaluated, the target image being generated based on a neural network model and a target prompt text;

an image and text input module configured to input the target image and the target prompt text to a target quality evaluation model, where the target quality evaluation model performs quality evaluation, based on target image feature information corresponding to the target image, target text feature information corresponding to the target prompt text, and interactive feature information, where the interactive feature information is obtained by fusing the target image feature information and the target text feature information; and

a quality evaluation result determining module configured to obtain a target quality evaluation result corresponding to the target image based on an output of the target quality evaluation model.

An embodiment of the present disclosure further provides an electronic device. The electronic device includes: one or more processors; and a storage apparatus configured to store one or more programs. The one or more programs, when executed by the one or more processors, cause the one or more processors to implement the method of image quality evaluation according to any one of the embodiments of the present disclosure.

An embodiment of the present disclosure further provides a storage medium including computer-executable instructions. The computer-executable instructions, when executed by a computer processor, are used to perform the method of image quality evaluation according to any one of the embodiments of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a method of image quality evaluation according to an embodiment of the present disclosure;

FIG. 2 is a schematic flowchart of another method of image quality evaluation according to an embodiment of the present disclosure;

FIG. 3 is a diagram of an example of a network architecture of a target quality evaluation model according to an embodiment of the present disclosure;

FIG. 4 is a schematic diagram of a structure of an apparatus of image quality evaluation according to an embodiment of the present disclosure; and

FIG. 5 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that the data involved in the technical solutions (including, but not limited to, the data itself and the access to or use of the data) shall comply with the requirements of corresponding laws, regulations, and relevant provisions.

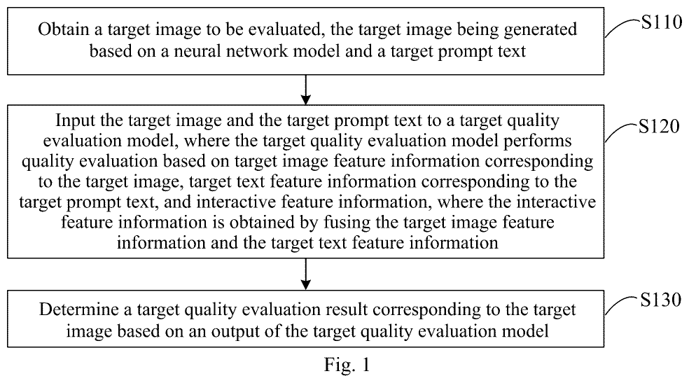

FIG. 1 is a schematic flowchart of a method of image quality evaluation according to an embodiment of the present disclosure. This embodiment of the present disclosure is applicable to a case of downloading and playing segments of a panoramic video, and the method may be performed by an apparatus of image quality evaluation. The apparatus may be implemented in the form of software and/or hardware. Optionally, the apparatus may be implemented by an electronic device, and the electronic device may be a mobile terminal, a PC, a server, or the like.

As shown in FIG. 1, the method of image quality evaluation specifically includes the following steps.

S110: Obtain a target image to be evaluated, the target image being generated based on a neural network model and a target prompt text.

The neural network model may be any artificial intelligence model for automatically generating a matching image or video based on a prompt text. For example, the neural network model may be a pre-trained language model. The pre-trained language model may be a generative language model obtained through pre-training on a large amount of language data. For example, the pre-trained language model may be a large language model (LLM). The target prompt text is text language information used to describe the target image that needs to be generated. The target image is an image that currently requires quality evaluation. The target image is an image that is automatically generated using the neural network model.

Specifically, the target prompt text may be input to the neural network model, and then the neural network model automatically generates the matching target image based on the input target prompt text and outputs the target image. In this way, the desired target image can be generated automatically using the neural network model. The image output by the neural network model may be used as the target image to be evaluated.

For example, S110 may include: using a video frame in a target video as the target image to be evaluated, where the target video is generated based on the neural network model and the target prompt text.

Specifically, in addition to an image, the neural network model can also automatically generate a video. Similarly, the target prompt text is input to the neural network model, and then the neural network model may automatically generate the matching target video based on the input target prompt text and output the target video. For quality evaluation of the target video, each video frame in the target video may be used as the target image to be evaluated, so as to perform image quality evaluation on each video frame.

S120: Input the target image and the target prompt text to a target quality evaluation model, where the target quality evaluation model performs quality evaluation, based on target image feature information corresponding to the target image, target text feature information corresponding to the target prompt text, and interactive feature information, where the interactive feature information is obtained by fusing the target image feature information and the target text feature information.

The target quality evaluation model may be a neural network model for automatic image quality evaluation. The target image feature information may be visual feature information of the target image. The target text feature information may be language feature information of the target prompt text. The interactive feature information may be association feature information of the target image and the target prompt text. The interactive feature information may be used to represent the consistency and association between the target image and the target prompt text. It should be noted that a higher consistency between the target prompt text and the generated target image indicates that the generated target image meets generation requirements more and has a higher quality. A higher quality of the target prompt text, for example, a more specific description, indicates that the generated target image is more accurate, for example, the image has more details and has a higher quality. The higher quality of the target prompt text, the higher quality of the target image, or the higher consistency between the target prompt text and the generated target image results, a higher overall evaluation quality of the target image.

Specifically, both the target image and the target prompt text are input to the target quality evaluation model for multi-dimensional quality evaluation. The target quality evaluation model respectively performs feature extraction on the input target image and the target prompt text, to obtain the target image feature information and the target text feature information, and fuses the target image feature information and the target text feature information, to obtain the interactive feature information, performs quality evaluation based on the target image feature information, the target text feature information, and the interactive feature information, so that comprehensive quality evaluation can be performed from three dimensions, namely, the quality of an image, the quality of a prompt text, and consistency between the image and the prompt text, and outputs a quality evaluation score. In this way, with the target quality evaluation model, the quality evaluation can be performed based not only on the characteristics of the image, but also on the characteristics of the prompt text, and the consistency between the image and the prompt text. As such, accurate quality evaluation of the generated image, and a higher degree of consistency of the subjective and objective visual perception can be achieved.

It should be noted that before the target image is input, if a size of the target image is not an input size required by the model, the target image needs to be scaled, to obtain a target image of the specified size, and the scaled target image and the target prompt text are then input to the target quality evaluation model for multi-dimensional quality evaluation.

S130: Determine a target quality evaluation result corresponding to the target image based on an output of the target quality evaluation model.

The target quality evaluation result may be a final quality evaluation result of the target image. The target quality evaluation result may be represented by the quality evaluation score, or by a classification result as high quality or low quality. A higher quality evaluation score indicates a higher quality of the generated image.

Specifically, the target quality evaluation score output by the target quality evaluation model may be determined directly as the target quality evaluation result corresponding to the target image. Alternatively, it may be detected whether the target quality evaluation score output by the target quality evaluation model is greater than or equal to a preset score, and if yes, it is determined that the target quality evaluation result corresponding to the target image is a high quality image; otherwise, it is determined that the target quality evaluation result corresponding to the target image is a low quality image.

For example, if the target image is a video frame in a target video, after step S130, the method may further include: determining a target quality evaluation result corresponding to the target video based on a target quality evaluation result corresponding to the video frame in the target video.

Specifically, based on the operations of steps S120 and S130 described above, a target quality evaluation score corresponding to each video frame in the target video may be determined, target quality evaluation scores for all video frames may be averaged, and the target quality evaluation result corresponding to the target video may be determined based on the resulting average quality evaluation score. For example, the average quality evaluation score may be determined directly as the target quality evaluation result corresponding to the target video. Alternatively, it may be detected whether the average quality evaluation score is greater than or equal to a preset score, and if yes, it is determined that the target quality evaluation result corresponding to the target video is a high quality video; otherwise, it is determined that the target quality evaluation result corresponding to the target video is a low quality video.

In the technical solution of this embodiment of the present disclosure, the target image generated based on the neural network model and the target prompt text is obtained, and the target image and the target prompt text are input to the target quality evaluation model, where the target quality evaluation model performs quality evaluation based on the target image feature information corresponding to the target image, the target text feature information corresponding to the target prompt text, and the interactive feature information, so that the target quality evaluation model can perform image quality evaluation from three dimensions, namely, the quality of an image, the quality of a prompt text, and the consistency between the image and the prompt text. Therefore, with the target quality evaluation model, the target quality evaluation result corresponding to the target image may be obtained more accurately. As such, the accuracy of quality evaluation of generated images is improved.

On the basis of the above technical solution, the target quality evaluation model is pre-trained based on sample images, sample prompt texts corresponding to the sample images, and actual sample quality scores.

The sample images may be generated images used in a training phase of the model. The sample images are also generated based on the neural network model and the sample prompt texts. There are a plurality of sample images. The actual sample quality scores may be true quality scores that the sample images have. The actual sample quality scores may be determined by using a subjective evaluation index, namely, a mean opinion score (MOS). The actual sample quality scores are used as output labels, to perform supervised model training, so that a target quality evaluation model capable of accurately evaluating image quality from multiple dimensions can be obtained.

For example, a training process of the target quality evaluation model may include the following steps S101 to S103.

S101: Input the sample images and the sample prompt texts to a quality evaluation model to be trained, to obtain sample quality evaluation scores corresponding to the sample images.

Specifically, the sample images and the sample prompt texts are input to a quality evaluation model to be trained, and the quality evaluation model to be trained respectively performs feature extraction on the input sample images and the input sample prompt texts, to obtain sample image feature information and sample text feature information, and fuses the sample image feature information and the sample text feature information, to obtain interactive feature information, and performs quality evaluation based on the sample image feature information, the sample text feature information, and the interactive feature information, to obtain the sample quality evaluation scores.

S102: Determine a training error based on the sample quality evaluation scores and actual sample quality scores.

Specifically, a training error between prediction values and the ground truth is determined based on a predetermined loss function, the sample quality evaluation scores, and the actual sample quality scores. For example, an absolute or a square difference between the sample quality evaluation scores and the actual sample quality scores may be determined as the training error.

For example, step S102 may include: determining a correlation coefficient between the sample quality evaluation scores and the actual sample quality scores; smoothing differences between the sample quality evaluation scores and the actual sample quality scores, to obtain smoothed target differences; and determining the training error based on the correlation coefficient and the target differences.

The correlation coefficient may be used to describe a degree of linear correlation between the sample quality evaluation scores and the actual sample quality scores, in order to measure the prediction accuracy of the model. The correlation coefficient ranges from −1 to 1.When the correlation coefficient is zero, it indicates that the sample quality evaluation scores are completely uncorrelated with the actual sample quality scores (that is, objective quality evaluation scores and subjective quality evaluation scores of the images have a significant difference with each other). When the correlation coefficient is 1 or −1, it indicates that the two sets of data are completely correlated (that is, the objective quality evaluation scores and the subjective quality evaluation scores of the images are the same). A higher correlation coefficient indicates a better model performance.

Specifically, based on sample quality evaluation scores and actual sample quality scores corresponding to a plurality of sample images used in each iterative training, a correlation coefficient r between the two sets of data (i.e., one for the sample quality evaluation scores and the other for the actual sample quality scores) is determined. Since the differences between the sample quality evaluation scores and the actual sample quality scores may have a turning point, and are not smooth, these differences need to be smoothed, to become more robust for outliers (i.e., points having shorter distance from a center) and anomalies. For example, an absolute value of a difference between a sample quality evaluation score and an actual sample quality score is determined. If the absolute value is less than 1, the absolute value is squared, and the squared value is multiplied by a preset weight (for example, 0.5) to obtain a smoothed target difference; or if the absolute value is greater than or equal to 1, the absolute value is subtracted by a preset value (for example, 0.5) to obtain a smoothed target difference. The squaring or absolute smoothing of the absolute values of the differences may allow the order of magnitude of a gradient to be controlled, so that a runaway (which means that the loss suddenly increases and keeps large) does not easily occur during training, and thus, the training effect of the model is improved. The training error may be obtained by performing weighted summation on an absolute value of the correlation coefficient, and the target differences, where a weight value corresponding to the correlation coefficient is negative, and a weight value corresponding to the target differences is positive. Alternatively, the training error may be obtained by subtracting an absolute value of the correlation coefficient from 1, to obtain a correlation loss, and performing weighted summation on the correlation loss and the target differences, where weight values of the correlation loss and the target differences are all positive.

S103: Propagate the training error back to the quality evaluation model to be trained, to adjust a model parameter of the quality evaluation model to be trained, determine the training to end until a preset convergence condition is reached, to obtain the target quality evaluation model.

Specifically, the training error is propagated back to the quality evaluation model to be trained, to automatically adjust the model parameter of the quality evaluation model to be trained, the training is determined to end until the preset convergence condition is reached, for example, a number of iterations is equal to a preset number, or the training error tends to be stable, to obtain the final target quality evaluation model. The above training enables the target quality evaluation model to accurately evaluate image quality from multiple dimensions, thereby improving the accuracy of the quality evaluation of the generated images.

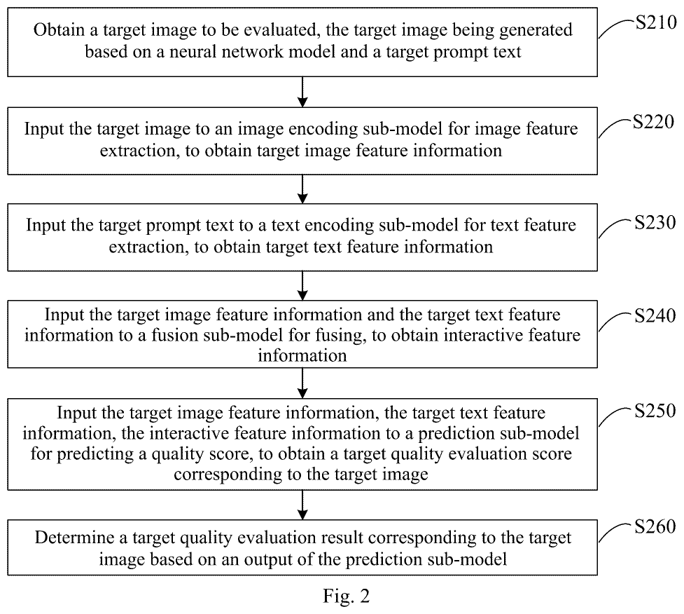

FIG. 2 is a schematic flowchart of another method of image quality evaluation according to an embodiment of the present disclosure. In this embodiment of the present disclosure, on the basis of the embodiment disclosed above, the step of “inputting the target image and the target prompt text to a target quality evaluation model” is optimized in a situation that the target quality evaluation model includes an image encoding sub-model, a text encoding sub-model, a fusion sub-model, and a prediction sub-model. Explanations of the terms identical or corresponding to those in the embodiments disclosed above are not repeated herein.

As shown in FIG. 2, the method of image quality evaluation specifically includes the following steps.

S210: Obtain a target image to be evaluated, the target image being generated based on a neural network model and a target prompt text.

S220: Input the target image to the image encoding sub-model for image feature extraction, to obtain target image feature information.

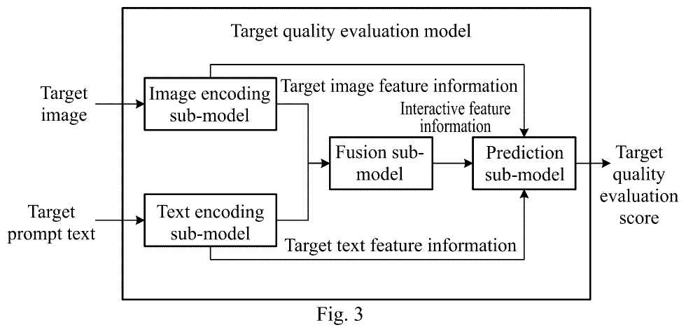

Specifically, referring to FIG. 3, the target image is input to the image encoding sub-model of the target quality evaluation model, and the image encoding sub-model performs visual feature extraction on the input target image, to obtain the extracted target image feature information.

S230: Input the target prompt text to the text encoding sub-model for text feature extraction, to obtain target text feature information.

Specifically, referring to FIG. 3, the target prompt text is input to the text encoding sub-model of the target quality evaluation model, and the text encoding sub-model performs language feature extraction on the input target prompt text, to obtain the extracted target text feature information.

For example, the image encoding sub-model and the text encoding sub-model are obtained through training on the basis of an image encoder and a text encoder of a cross-modal pre-trained model. The cross-modal pre-trained model is pre-trained based on a dataset of image-text pairs through contrastive learning.

The cross-modal pre-trained model (contrastive language-image pretraining, CLIP) can perform contrastive learning on images and texts, thereby achieve a more comprehensive understanding and representation of the images and texts. The contrastive learning is performed by encoding the images and texts, and computing similarities the image and texts to maximize the similarities. The cross-modal pre-trained model includes the image encoder and the text encoder to understand both the images and texts for a more comprehensive understanding and representation.

Specifically, during training of the image encoding sub-model and the text encoding sub-model, the image encoder and the text encoder of the cross-modal pre-trained model are used as initial models for the image encoding sub-model and the text encoding sub-model, respectively, in order to perform the training on the basis of the image encoder and the text encoder, to obtain the trained image encoding sub-model and text encoding sub-model. In this way, the capabilities of the target quality evaluation model to understand and generalize images and texts are further improved, thereby further improving the accuracy of image quality evaluation.

S240: Input the target image feature information and the target text feature information to the fusion sub-model for fusing, to obtain interactive feature information.

Specifically, referring to FIG. 3, the target image feature information and the target text feature information are input to the fusion sub-model for associative fusing the two features, to obtain the interactive feature information that can represent a degree of association of the two features.

For example, step S240 may include: inputting the target image feature information and the target text feature information to the fusion sub-model for bilinear pooling, to obtain the interactive feature information.

Specifically, the fusion sub-model may implement the associative fusion of the two features through bilinear pooling of the input target image feature information and target text feature information. For example, bilinear fusion (i.e. multiplication) is performed on the target image feature information and the target text feature information, to obtain first matrices, and sum pooling or max pooling is performed on all the first matrices, to obtain a second matrix, and the second matrix is expanded into a vector, and the vector is normalized to obtain the fused interactive feature information. The use of the bilinear pooling may allow the interactive feature information to be determined more accurately, thereby further improving the accuracy of the quality evaluation.

S250: Input the target image feature information, the target text feature information, the interactive feature information to the prediction sub-model for predicting a quality score, to obtain a target quality evaluation score corresponding to the target image.

The prediction sub-model may include a fully connected layer for mapping feature information to evaluation scores. Specifically, referring to FIG. 3, feature concatenation may be performed on the target image feature information, the target text feature information, and the interactive feature information, all the concatenated feature information is input to the prediction sub-model, and the prediction sub-model performs image quality evaluation based on the input three features, from three dimensions, namely, the quality of an image, the quality of a prompt text, and the consistency between the image and the prompt text, to obtain an accurately predicted target quality evaluation score.

S260: Determine a target quality evaluation result corresponding to the target image based on an output of the prediction sub-model.

Specifically, referring to FIG. 3, the prediction sub-model outputs the predicted target quality evaluation score, and determines a final target quality evaluation result of the target image based on the output target quality evaluation score. As such, more accurate quality evaluation of generated images may be implemented by using the target quality evaluation model.

In the technical solution of this embodiment of the present disclosure, the use of the target quality evaluation model including the image encoding sub-model, the text encoding sub-model, the fusion sub-model, and the prediction sub-model may allow for accurate feature extraction on the image and the prompt text, and fusion of the extracted image feature information and text feature information, so that the image feature information, the text feature information, and the interactive feature information may be used to perform image quality evaluation, from three dimensions, namely, the quality of an image, the quality of a prompt text, and the consistency between the image and the prompt text, which improves the accuracy of the quality evaluation of the generated images.

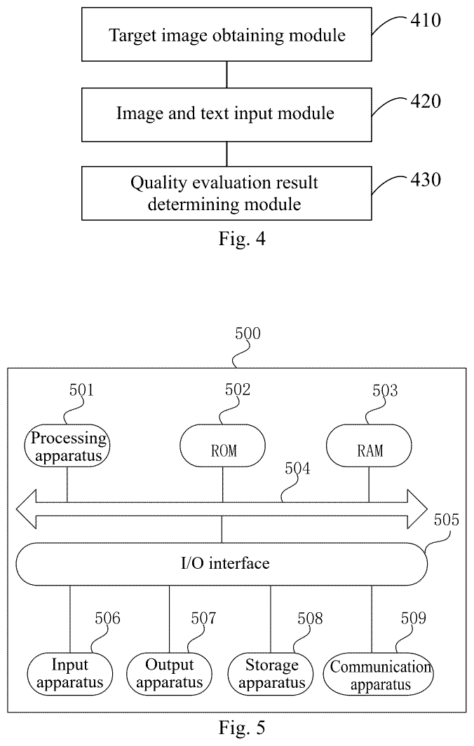

FIG. 4 is a schematic diagram of a structure of an apparatus of image quality evaluation according to an embodiment of the disclosure. As shown in FIG. 4, the apparatus specifically includes: a target image obtaining module 410, an image and text input module 420, and a quality evaluation result determining module 430.

The target image obtaining module 410 is configured to obtain a target image to be evaluated, the target image being generated based on a neural network model and a target prompt text. The image and text input module 420 is configured to input the target image and the target prompt text to a target quality evaluation model, where the target quality evaluation model performs quality evaluation, based on target image feature information corresponding to the target image, target text feature information corresponding to the target prompt text, and interactive feature information, where the interactive feature information is obtained by fusing the target image feature information and the target text feature information. The quality evaluation result determining module 430 is configured to obtain a target quality evaluation result corresponding to the target image based on an output of the target quality evaluation model.

In the technical solution provided in this embodiment of the present disclosure, the target image generated based on the neural network model and the target prompt text is obtained, and the target image and the target prompt text are input to the target quality evaluation model, where the target quality evaluation model performs quality evaluation, based on target image feature information corresponding to the target image, the target text feature information corresponding to the target prompt text, and the interactive feature information, so that the target quality evaluation model can perform image quality evaluation from three dimensions, namely, the quality of an image, the quality of a prompt text, and the consistency between the image and the prompt text. Therefore, the target quality evaluation result corresponding to the target image may be obtained more accurately by using the target quality evaluation model. As such, the accuracy of quality evaluation of generated images is improved.

On the basis of the above technical solution, the target quality evaluation model includes an image encoding sub-model, a text encoding sub-model, a fusion sub-model, and a prediction sub-model; and the image and text input module 420 includes: an image feature extraction unit configured to input the target image to the image encoding sub-model for image feature extraction, to obtain the target image feature information; a text feature extraction unit configured to input the target prompt text to the text encoding sub-model for text feature extraction, to obtain the target text feature information; a feature fusion unit configured to input the target image feature information and the target text feature information to the fusion sub-model for fusing, to obtain the interactive feature information; and a feature input unit configured to input the target image feature information, the target text feature information, the interactive feature information to the prediction sub-model for predicting a quality score, to obtain a target quality evaluation score corresponding to the target image.

On the basis of the above technical solutions, the image encoding sub-model and the text encoding sub-model are obtained through training on the basis of an image encoder and a text encoder of a cross-modal pre-trained model; where the cross-modal pre-trained model is pre-trained based on a dataset of image-text pairs through contrastive learning.

On the basis of the above technical solutions, the feature fusion unit is specifically configured to: input the target image feature information and the target text feature information to the fusion sub-model for bilinear pooling, to obtain the interactive feature information.

On the basis of the above technical solutions, the target quality evaluation model is pre-trained based on sample images, sample prompt texts corresponding to the sample images, and actual sample quality scores; and

the apparatus further includes: a target quality evaluation model training module, which includes:

a sample quality evaluation score determining unit configured to input the sample images and the sample prompt texts to a quality evaluation model to be trained, to obtain sample quality evaluation scores corresponding to the sample images;

a training error determining unit configured to determine a training error based on the sample quality evaluation scores and the actual sample quality scores; and

a model parameter adjustment unit configured to propagate the training error back to the quality evaluation model to be trained, to adjust a model parameter of the quality evaluation model to be trained, determine the training to end until a preset convergence condition is reached, to obtain the target quality evaluation model.

On the basis of the above technical solutions, the training error determining unit is specifically configured to: determine a correlation coefficient between the sample quality evaluation scores and the actual sample quality scores; smooth differences between the sample quality evaluation scores and the actual sample quality scores, to obtain smoothed target differences; and determine the training error based on the correlation coefficient and the target differences.

On the basis of the above technical solutions, the target image obtaining module 410 is specifically configured to: use a video frame in a target video as the target image to be evaluated, where the target video is generated based on the neural network model and the target prompt text; and

the apparatus further includes: a video evaluation result determining module configured to, after the target quality evaluation result corresponding to the target image is obtained based on the output of the target quality evaluation model, determine a target quality evaluation result corresponding to the target video based on a target quality evaluation result corresponding to the video frame in the target video.

The apparatus of image quality evaluation provided in this embodiment of the present disclosure can perform the method of image quality evaluation provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

FIG. 5 is a schematic diagram of a structure of an electronic device according to an embodiment of the present disclosure. Reference is made to FIG. 5 below, which is a schematic diagram of a structure of an electronic device (such as a terminal device or a server in FIG. 5) 500 suitable for implementing embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to one another through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the methods shown in the flowcharts. In such an embodiment, the computer program may be downloaded and installed from a network through the communication apparatus 509, installed from the storage apparatus 508, or installed from the ROM 502. When the computer program is executed by the processing apparatus 501, the above-mentioned functions defined in the methods of the embodiments of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the method of image quality evaluation according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the method of image quality evaluation according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a target image to be evaluated that is generated based on a neural network model and a target prompt text; input the target image and the target prompt text to a target quality evaluation model, where the target quality evaluation model performs quality evaluation, based on target image feature information corresponding to the target image, target text feature information corresponding to the target prompt text, and interactive feature information, where the interactive feature information is obtained by fusing the target image feature information and the target text feature information; and determine a target quality evaluation result corresponding to the target image based on an output of the target quality evaluation model.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, [Example 1] provides a method of image quality evaluation. The method includes:

obtaining a target image to be evaluated, the target image being generated based on a neural network model and a target prompt text;

inputting the target image and the target prompt text to a target quality evaluation model, where the target quality evaluation model performs quality evaluation, based on target image feature information corresponding to the target image, target text feature information corresponding to the target prompt text, and interactive feature information, where the interactive feature information is obtained by fusing the target image feature information and the target text feature information; and

determining a target quality evaluation result corresponding to the target image based on an output of the target quality evaluation model.

According to one or more embodiments of the present disclosure, [Example 2] provides a method of image quality evaluation. The method further includes:

optionally, the target quality evaluation model includes an image encoding sub-model, a text encoding sub-model, a fusion sub-model, and a prediction sub-model; and

the inputting the target image and the target prompt text to a target quality evaluation model includes:

inputting the target image to the image encoding sub-model for image feature extraction, to obtain the target image feature information;

inputting the target prompt text to the text encoding sub-model for text feature extraction, to obtain the target text feature information;

inputting the target image feature information and the target text feature information to the fusion sub-model for fusing, to obtain the interactive feature information; and

inputting the target image feature information, the target text feature information, the interactive feature information to the prediction sub-model for prediction a quality score, to obtain a target quality evaluation score corresponding to the target image.

According to one or more embodiments of the present disclosure, [Example 3] provides a method of image quality evaluation. The method further includes:

optionally, the image encoding sub-model and the text encoding sub-model are obtained through training on the basis of an image encoder and a text encoder of a cross-modal pre-trained model;

where the cross-modal pre-trained model is pre-trained based on a dataset of image-text pairs through contrastive learning.

According to one or more embodiments of the present disclosure, [Example 4] provides a method of image quality evaluation. The method further includes:

optionally, the inputting the target image feature information and the target text feature information to the fusion sub-model for fusing, to obtain interactive feature information includes:

inputting the target image feature information and the target text feature information to the fusion sub-model for bilinear pooling, to obtain the interactive feature information.

According to one or more embodiments of the present disclosure, [Example 5] provides a method of image quality evaluation. The method further includes:

optionally, the target quality evaluation model is pre-trained based on sample images, sample prompt texts corresponding to the sample images, and actual sample quality scores; and

a process of training the target quality evaluation model includes:

inputting the sample images and the sample prompt texts to a quality evaluation model to be trained, to obtain sample quality evaluation scores corresponding to the sample images;

determining a training error based on the sample quality evaluation scores and the actual sample quality scores; and

propagating the training error back to the quality evaluation model to be trained, to adjust a model parameter of the quality evaluation model to be trained, and determine the training to end until a preset convergence condition is reached, to obtain the target quality evaluation model.

According to one or more embodiments of the present disclosure, [Example 6] provides a method of image quality evaluation. The method further includes:

optionally, the determining a training error based on the sample quality evaluation scores and the actual sample quality scores includes:

determining a correlation coefficient between the sample quality evaluation scores and the actual sample quality scores;

smoothing differences between the sample quality evaluation scores and the actual sample quality scores, to obtain smoothed target differences; and

determining the training error based on the correlation coefficient and the target differences.

According to one or more embodiments of the present disclosure, [Example 7] provides a method of image quality evaluation. The method further includes:

optionally, the obtaining a target image to be evaluated, the target image being generated based on a neural network model and a target prompt text includes:

using a video frame in a target video as the target image to be evaluated, where the target video is generated based on the neural network model and the target prompt text; and

after the target quality evaluation result corresponding to the target image is obtained based on the output of the target quality evaluation model, the method further includes:

determining a target quality evaluation result corresponding to the target video based on a target quality evaluation result corresponding to the video frame in the target video.

According to one or more embodiments of the present disclosure, [Example 8] provides an apparatus of image quality evaluation. The apparatus includes:

a target image obtaining module configured to obtain a target image to be evaluated, the target image being generated based on a neural network model and a target prompt text;

an image and text input module configured to input the target image and the target prompt text to a target quality evaluation model, where the target quality evaluation model performs quality evaluation, based on target image feature information corresponding to the target image, target text feature information corresponding to the target prompt text, and interactive feature information, where the interactive feature information is obtained by fusing the target image feature information and the target text feature information; and

a quality evaluation result determining module configured to obtain a target quality evaluation result corresponding to the target image based on an output of the target quality evaluation model.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method of image quality evaluation, comprising:
obtaining a target image to be evaluated, the target image being generated based on a neural network model and a target prompt text;
inputting the target image and the target prompt text to a target quality evaluation model, wherein the target quality evaluation model performs quality evaluation, based on target image feature information corresponding to the target image, target text feature information corresponding to the target prompt text, and interactive feature information, and wherein the interactive feature information is obtained by fusing the target image feature information and the target text feature information; and
determining a target quality evaluation result corresponding to the target image based on an output of the target quality evaluation model.

2. The method of image quality evaluation according to claim 1, wherein the target quality evaluation model comprises an image encoding sub-model, a text encoding sub-model, a fusion sub-model, and a prediction sub-model; and
the inputting the target image and the target prompt text to a target quality evaluation model comprises:
inputting the target image to the image encoding sub-model for image feature extraction, to obtain the target image feature information;
inputting the target prompt text to the text encoding sub-model for text feature extraction, to obtain the target text feature information;
inputting the target image feature information and the target text feature information to the fusion sub-model for fusing, to obtain the interactive feature information; and
inputting the target image feature information, the target text feature information, the interactive feature information to the prediction sub-model for predicting a quality score, to obtain a target quality evaluation score corresponding to the target image.

3. The method of image quality evaluation according to claim 2, wherein the image encoding sub-model and the text encoding sub-model are obtained through training on a basis of an image encoder and a text encoder of a cross-modal pre-trained model; and
wherein the cross-modal pre-trained model is pre-trained based on a dataset of image-text pairs through contrastive learning.

4. The method of image quality evaluation according to claim 2, wherein the inputting the target image feature information and the target text feature information to the fusion sub-model for fusing, to obtain interactive feature information, comprises:
inputting the target image feature information and the target text feature information to the fusion sub-model for bilinear pooling, to obtain the interactive feature information.

5. The method of image quality evaluation according to claim 1, wherein the target quality evaluation model is pre-trained based on sample images, sample prompt texts corresponding to the sample images, and actual sample quality scores; and
a process of training the target quality evaluation model comprises:
inputting the sample images and the sample prompt texts to a quality evaluation model to be trained, to obtain sample quality evaluation scores corresponding to the sample images;
determining a training error based on the sample quality evaluation scores and the actual sample quality scores; and
propagating the training error back to the quality evaluation model to be trained, to adjust a model parameter of the quality evaluation model to be trained, and determining the training to end until a preset convergence condition is reached, to obtain the target quality evaluation model.

6. The method of image quality evaluation according to claim 5, wherein the determining a training error based on the sample quality evaluation scores and the actual sample quality scores comprises:
determining a correlation coefficient between the sample quality evaluation scores and the actual sample quality scores;
smoothing differences between the sample quality evaluation scores and the actual sample quality scores, to obtain smoothed target differences; and
determining the training error based on the correlation coefficient and the target differences.

7. The method of image quality evaluation according to claim 1, wherein the obtaining a target image to be evaluated,
the target image being generated based on a neural network model and a target prompt text, comprises:
using a video frame in a target video as the target image to be evaluated, wherein the target video is generated based on the neural network model and the target prompt text; and
after the target quality evaluation result corresponding to the target image is obtained based on the output of the target quality evaluation model, the method further comprises:
determining a target quality evaluation result corresponding to the target video based on a target quality evaluation result corresponding to the video frame in the target video.

8. The method of image quality evaluation according to claim 3, wherein the inputting the target image feature information and the target text feature information to the fusion sub-model for fusing, to obtain interactive feature information, comprises:
inputting the target image feature information and the target text feature information to the fusion sub-model for bilinear pooling, to obtain the interactive feature information.

9. The method of image quality evaluation according to claim 2, wherein the target quality evaluation model is pre-trained based on sample images, sample prompt texts corresponding to the sample images, and actual sample quality scores; and
a process of training the target quality evaluation model comprises:
inputting the sample images and the sample prompt texts to a quality evaluation model to be trained, to obtain sample quality evaluation scores corresponding to the sample images;
determining a training error based on the sample quality evaluation scores and the actual sample quality scores; and
propagating the training error back to the quality evaluation model to be trained, to adjust a model parameter of the quality evaluation model to be trained, and determining the training to end until a preset convergence condition is reached, to obtain the target quality evaluation model.

10. The method of image quality evaluation according to claim 9, wherein the determining a training error based on the sample quality evaluation scores and the actual sample quality scores comprises:
determining a correlation coefficient between the sample quality evaluation scores and the actual sample quality scores;
smoothing differences between the sample quality evaluation scores and the actual sample quality scores, to obtain smoothed target differences; and
determining the training error based on the correlation coefficient and the target differences.

11. The method of image quality evaluation according to claim 2, wherein the obtaining a target image to be evaluated,
the target image being generated based on a neural network model and a target prompt text, comprises:
using a video frame in a target video as the target image to be evaluated, wherein the target video is generated based on the neural network model and the target prompt text; and
after the target quality evaluation result corresponding to the target image is obtained based on the output of the target quality evaluation model, the method further comprises:
determining a target quality evaluation result corresponding to the target video based on a target quality evaluation result corresponding to the video frame in the target video.

12. The method of image quality evaluation according to claim 3, wherein the obtaining a target image to be evaluated, the target image being generated based on a neural network model and a target prompt text, comprises:
using a video frame in a target video as the target image to be evaluated, wherein the target video is generated based on the neural network model and the target prompt text; and
after the target quality evaluation result corresponding to the target image is obtained based on the output of the target quality evaluation model, the method further comprises:
determining a target quality evaluation result corresponding to the target video based on a target quality evaluation result corresponding to the video frame in the target video.

13. An electronic device, comprising:
at least one processor; and
at least one memory, configured to store at least one program, wherein the at least one program, when executed by the at least one processor, cause the at least one processor to perform a method of image quality evaluation, which comprises:
obtaining a target image to be evaluated, the target image being generated based on a neural network model and a target prompt text;
inputting the target image and the target prompt text to a target quality evaluation model, wherein the target quality evaluation model performs quality evaluation, based on target image feature information corresponding to the target image, target text feature information corresponding to the target prompt text, and interactive feature information, wherein the interactive feature information is obtained by fusing the target image feature information and the target text feature information; and
determining a target quality evaluation result corresponding to the target image based on an output of the target quality evaluation model.

14. The electronic device according to claim 13, wherein the target quality evaluation model comprises an image encoding sub-model, a text encoding sub-model, a fusion sub-model, and a prediction sub-model; and
the inputting the target image and the target prompt text to a target quality evaluation model comprises:
inputting the target image to the image encoding sub-model for image feature extraction, to obtain the target image feature information;
inputting the target prompt text to the text encoding sub-model for text feature extraction, to obtain the target text feature information;
inputting the target image feature information and the target text feature information to the fusion sub-model for fusing, to obtain the interactive feature information; and
inputting the target image feature information, the target text feature information, the interactive feature information to the prediction sub-model for predicting a quality score, to obtain a target quality evaluation score corresponding to the target image.

15. The electronic device according to claim 14, wherein the image encoding sub-model and the text encoding sub-model are obtained through training on a basis of an image encoder and a text encoder of a cross-modal pre-trained model;
wherein the cross-modal pre-trained model is pre-trained based on a dataset of image-text pairs through contrastive learning.

16. The electronic device according to claim 14, wherein the inputting the target image feature information and the target text feature information to the fusion sub-model for fusing, to obtain interactive feature information, comprises:
inputting the target image feature information and the target text feature information to the fusion sub-model for bilinear pooling, to obtain the interactive feature information.

17. The electronic device according to claim 13, wherein the target quality evaluation model is pre-trained based on sample images, sample prompt texts corresponding to the sample images, and actual sample quality scores; and
a process of training the target quality evaluation model comprises:
inputting the sample images and the sample prompt texts to a quality evaluation model to be trained, to obtain sample quality evaluation scores corresponding to the sample images;
determining a training error based on the sample quality evaluation scores and the actual sample quality scores; and
propagating the training error back to the quality evaluation model to be trained, to adjust a model parameter of the quality evaluation model to be trained, and determining the training to end until a preset convergence condition is reached, to obtain the target quality evaluation model.

18. The electronic device according to claim 17, wherein the determining a training error based on the sample quality evaluation scores and the actual sample quality scores comprises:
determining a correlation coefficient between the sample quality evaluation scores and the actual sample quality scores;
smoothing differences between the sample quality evaluation scores and the actual sample quality scores, to obtain smoothed target differences; and
determining the training error based on the correlation coefficient and the target differences.

19. The electronic device according to claim 13, wherein the obtaining a target image to be evaluated, the target image being generated based on a neural network model and a target prompt text, comprises:
using a video frame in a target video as the target image to be evaluated, wherein the target video is generated based on the neural network model and the target prompt text; and
after the target quality evaluation result corresponding to the target image is obtained based on the output of the target quality evaluation model, the method further comprises:
determining a target quality evaluation result corresponding to the target video based on a target quality evaluation result corresponding to the video frame in the target video.

20. A non-transitory computer-readable storage medium, containing computer-executable instructions, wherein the computer-executable instructions, when executed by a computer processor, perform a method of image quality evaluation, which comprises:
obtaining a target image to be evaluated, the target image being generated based on a neural network model and a target prompt text;
inputting the target image and the target prompt text to a target quality evaluation model, wherein the target quality evaluation model performs quality evaluation, based on target image feature information corresponding to the target image, target text feature information corresponding to the target prompt text, and interactive feature information, wherein the interactive feature information is obtained by fusing the target image feature information and the target text feature information; and
determining a target quality evaluation result corresponding to the target image based on an output of the target quality evaluation model.
